(19) United States
(12) Patent Application Publication
(10) Pub. No.: US 2026/0219176 A1
(43) Pub. Date: Jul. 30, 2026

(54) SPECTROSCOPIC ANALYSIS DEVICE, SPECTROSCOPIC ANALYSIS METHOD, SPECTROSCOPIC ANALYSIS PROGRAM, LEARNING DEVICE, LEARNING METHOD, AND LEARNING PROGRAM

(71) Applicant: HORIBA, LTD., Kyoto-shi, Kyoto (JP)

(72) Inventors: Takashi SAITO, Kyoto-shi, Kyoto (JP); Yuji GYOTEN, Kyoto-shi, Kyoto (JP); Katsumi NISHIMURA, Kyoto-shi, Kyoto (JP)

(73) Assignee: HORIBA, LTD., Kyoto-shi, Kyoto (JP)

(21) Appl. No.: 19/141,625

(22) PCT Filed: Dec. 6, 2023
(86) PCT No.: PCT/JP2023/043717

§ 371 Date: Jun. 20, 2025

(30) Foreign Application Priority Data
Dec. 22, 2022 (JP) 2022-205350

(51) Int. Cl. G01N 21/3504

(52) U.S. Cl. CPC G01N 21/3504; G01N 2021/3509; G01N 2201/12

(57) ABSTRACT

The present invention includes a spectrum generation unit that generates a spectrum of light transmitted through a sample, a storage unit that stores a standard calibration curve created by a standard device and a standard spectrum that is a spectrum generated by the standard device serving as a standard of a spectroscopic analysis device, a correction unit that corrects a measurement spectrum that is a spectrum of the sample generated by the spectrum generation unit or the standard calibration curve based on a result of comparing a reference spectrum that is a spectrum of a standard gas generated by the spectrum generation unit with the standard spectrum, and a concentration calculation unit that calculates the concentration of the component to be measured based on the standard calibration curve and the measurement spectrum that has been corrected or the standard calibration curve that has been corrected and the measurement spectrum.

### TECHNICAL FIELD

The present invention relates to a spectroscopic analysis device, a spectroscopic analysis method, a spectroscopic analysis program, a learning device, a learning method, and a learning program.

### BACKGROUND ART

As disclosed in Patent Literature 1, a Fourier transform infrared spectrometer (FTIR spectrometer) performs multivariate analysis on an absorbance (or transmittance) spectrum of a sample to calculate a concentration of a component to be measured in the sample.

Here, the multivariate analysis is a method in which a product-sum operation as shown in the following Formula 1 is performed using an appropriate constant coefficient v_{X,k}, where A (λₖ) is the absorbance spectrum of a sample, and c_{X} is the concentration of a component X to be measured, for example. The following arithmetic expression is an example, and a quadratic or cubic high-order term related to A(λₖ) may be included, or a product of A(λₖ) may be included.

$$\begin{matrix}[ Math . 1 ] & \\ {c}_{X} = {\sum }_{k} {v}_{X , k} A ( {λ}_{k} ) & \end{matrix}$$

Here, v_{X,k} in the above arithmetic expression is a constant parameter that varies depending on the component X to be measured, and is called “calibration curve coefficient”.

This calibration curve coefficient may be different for each FTIR analyzer with the same component to be measured. This is because there are individual differences in terms of the spectral shapes output from the interferometers used in FTIR analyzers even though gas with the same composition and concentration is used. Thus, to calculate the concentration of the component to be measured with high accuracy in each FTIR analyzer, a calibration curve is created for each FTIR analyzer.

However, since a calibration curve is created for each FTIR analyzer, not only labor cost and time for creating the calibration curve increase, but also the cost of consumables such as gas for creating the calibration curve also increases.

### CITATION LIST

### Patent Literature

Patent Literature 1: WO 2021/005900 A

### SUMMARY OF INVENTION

### Technical Problem

The present invention has been made in view of the above-described problems, and a main object thereof is to accurately obtain the concentration of a component to be measured from a measurement spectrum without obtaining a calibration curve for each spectroscopic analysis device.

### Solution to Problem

That is, a spectroscopic analysis device according to the present invention is a spectroscopic analysis device that irradiates a sample with light to analyze a component to be measured contained in the sample, the spectroscopic analysis device including a light irradiation unit that irradiates the sample with light, a photodetector that detects light transmitted through the sample and obtains a detection signal, a spectrum generation unit that generates a spectrum of light transmitted through the sample based on the detection signal, a storage unit that stores a standard calibration curve and a standard spectrum, the standard calibration curve being created by a standard device serving as a standard of the spectroscopic analysis device using a standard gas, the standard spectrum being a spectrum of the standard gas generated by the standard device, a correction unit that compares a reference spectrum that is a spectrum of the standard gas generated by the spectrum generation unit with the standard spectrum and corrects a measurement spectrum that is a spectrum of the sample generated by the spectrum generation unit or the standard calibration curve based on a difference in wavenumber or half-value width between peaks of the reference spectrum and the standard spectrum, and a concentration calculation unit that calculates a concentration of the component to be measured based either on the standard calibration curve and the measurement spectrum that has been corrected or on the standard calibration curve that has been corrected and the measurement spectrum.

In such a spectroscopic analysis device, the reference spectrum that is a spectrum of the standard gas generated by the spectrum generation unit is compared with the standard spectrum that is the spectrum of the standard gas generated by the standard device, and the measurement spectrum that is a spectrum of the sample generated by the spectrum generation unit or the standard calibration curve is corrected based on the difference in the wavenumber or half-value width of the peaks. Thus, the concentration of the component to be measured can be obtained with good accuracy without obtaining a calibration curve of the spectroscopic analysis device. In addition, since it is not necessary to obtain a calibration curve for each spectroscopic analysis device, labor costs and time for creating the calibration curve can be reduced, and the cost of consumables such as gas for creating the calibration curve can also be reduced.

As a specific embodiment of the correction unit, the correction unit desirably compares the standard spectrum with the reference spectrum and corrects the measurement spectrum or the standard calibration curve based on at least two of a difference in wavenumber, a difference in height, or a difference in half-value width between the peaks of the reference spectrum and the standard spectrum.

As a more specific embodiment of the correction unit, the correction unit desirably obtains a device difference parameter including at least two of a wavenumber axis scaling ratio α obtained from the wavenumber of the peaks of the standard spectrum and the reference spectrum, an absorbance scaling ratio β obtained from one or both of a height and the half-value width of the peaks, or a difference w_{g} between half-value widths obtained from half-value widths of the peaks, and corrects the measurement spectrum or the standard calibration curve based on the device difference parameter.

The correction unit may estimate the device difference parameter using a learning model obtained in advance.

A spectroscopic analysis method according to the present invention is a spectroscopic analysis method using a spectroscopic analysis device that irradiates a sample with light to analyze a component to be measured contained in the sample, the spectroscopic analysis method including using a standard calibration curve created by a standard device serving as a standard of the spectroscopic analysis device using a standard gas, and a spectrum of the standard gas generated by the standard device, comparing a reference spectrum that is a spectrum of the standard gas generated by the spectroscopic analysis device with the standard spectrum to correct a measurement spectrum that is a spectrum of the sample generated by the spectroscopic analysis or the standard calibration curve based on a difference in wavenumber or half-value width between peaks of the reference spectrum and the standard spectrum, and calculating a concentration of the component to be measured based on the standard calibration curve and the measurement spectrum that has been corrected or the standard calibration curve that has been corrected and the measurement spectrum.

A spectroscopic analysis program according to the present invention is a spectroscopic analysis program used in a spectroscopic analysis device that irradiates a sample with light to analyze a component to be measured contained in the sample, the spectroscopic analysis program causing a computer to function as a spectrum generation unit that generates a spectrum of light transmitted through the sample, function as a storage unit that stores a standard calibration curve and a standard spectrum, the standard calibration curve being created by a standard device serving as a standard of the spectroscopic analysis device using a standard gas, the standard spectrum being a spectrum of the standard gas generated by the standard device, function as a correction unit that compares a reference spectrum that is a spectrum of the standard gas generated by the spectrum generation unit with the standard spectrum and corrects a measurement spectrum that is a spectrum of the sample generated by the spectrum generation unit or the standard calibration curve based on a difference in wavenumber or half-value width between peaks of the reference spectrum and the standard spectrum, and function as a concentration calculation unit that calculates a concentration of the component to be measured based on the standard calibration curve and the measurement spectrum corrected by the correction unit or the standard calibration curve corrected by the correction unit and the measurement spectrum.

A learning device according to the present invention is a learning device that generates the learning model for obtaining the device difference parameter from the reference spectrum, the learning device including a simulation unit that generates a plurality of virtual spectra based on the standard spectrum and each of a plurality of the device difference parameters, and a learning unit that generates a learned model based on a learning data set including the plurality of virtual spectra generated by the simulation unit and the plurality of device difference parameters used to generate the virtual spectra.

To generate a machine learning model considering a noise component overlapping the reference spectrum, the simulation unit desirably applies a noise component to each of the plurality of virtual spectra, and the learning unit desirably generates the learned model based on a learning data set including the plurality of virtual spectra to which the noise component is given and the plurality of device difference parameters used to generate the virtual spectra.

A machine learning method according to the present invention is a learning method for generating a learning model for obtaining the device difference parameter from the reference spectrum, the learning method including generating a plurality of virtual spectra based on the standard spectrum and each of a plurality of the device difference parameters, and generating a learned model based on a learning data set including the plurality of virtual spectra that have been generated and the plurality of device difference parameters used to generate the virtual spectra.

Further, a learning program according to the present invention is a learning program for generating a learning model for obtaining the device difference parameter from the reference spectrum, the learning program causing a computer to function as a simulation unit that generates a plurality of virtual spectra based on the standard spectrum and each of a plurality of the device difference parameters, and function as a learning unit that generates a learned model based on a learning data set including the plurality of virtual spectra that have been generated and the plurality of device difference parameters used to generate the virtual spectra.

### Advantageous Effects of Invention

The present invention configured as described above can obtain the concentration of a component to be measured with good accurately from a measurement spectrum without obtaining a calibration curve for each spectroscopic analysis device.

### BRIEF DESCRIPTION OF DRAWINGS

FIG. 1 is a schematic diagram illustrating a spectroscopic analysis device according to an embodiment of the present invention.

FIG. 2 is a functional block diagram for an arithmetic processing device according to the embodiment.

FIG. 3 is a diagram illustrating a difference in absorbance spectrum when the same gas is measured.

FIG. 4 is a diagram illustrating a method for calculating device difference parameters in the embodiment.

FIG. 5 is a diagram illustrating a method for calculating device difference parameters in the embodiment.

FIG. 6 is a diagram illustrating an example of a measurement spectrum correction method according to the embodiment.

FIG. 7 is a flowchart illustrating a spectroscopic analysis method of the embodiment.

FIG. 8 is a functional block diagram for an arithmetic processing device according to a modified embodiment.

FIG. 9 is a diagram illustrating a simulation of a simulation unit according to a modified embodiment.

### DESCRIPTION OF EMBODIMENTS

### One Embodiment of Present Invention

Hereinafter, an embodiment of a spectroscopic analysis device according to the present invention will be described with reference to the drawings.

All the drawings described below are schematically illustrated with appropriate omission or exaggeration for easy understanding. The same components are denoted by the same reference numerals, and the description thereof will be omitted as appropriate.

### <Device Configuration>

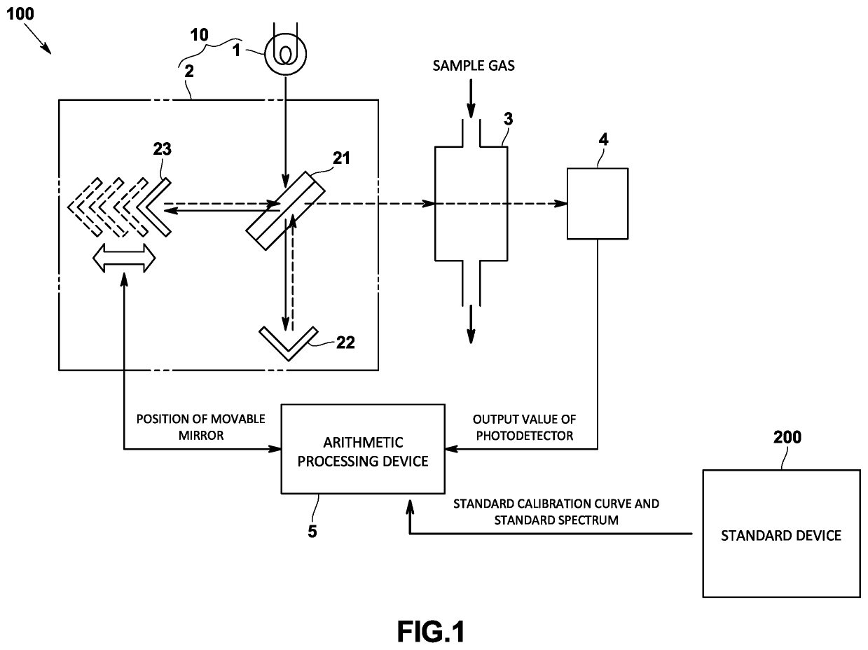

A spectroscopic analysis device 100 of the present embodiment irradiates sample gas with light to analyze a component to be measured contained in the sample gas. The spectroscopic analysis device is an analysis device using Fourier transform infrared spectroscopy (FTIR), including an infrared light source 1, an interferometer (spectroscopic unit) 2, a measurement cell 3, a photodetector 4, and an arithmetic processing device 5 as illustrated in FIG. 1.

The infrared light source 1 emits infrared light having a broad spectrum (continuous light including light having a large number of wavenumbers). For the infrared light source, for example, a tungsten-iodine lamp or a high-luminance ceramic light source is used.

As illustrated in the drawing, the interferometer 2 uses a so-called Michelson interferometer including one half mirror (beam splitter) 21, a fixed mirror 22, and a movable mirror 23. The light from the infrared light source 1 incident on the interferometer 2 is divided into reflected light and transmitted light by the half mirror 21. One piece of light is reflected by the fixed mirror 22, the other is reflected by the movable mirror 23, returns to the half mirror 21 again, is combined, and is emitted from the interferometer 2. The infrared light source 1 and the interferometer (spectroscopic unit) 2 constitute a light irradiation unit 10 that irradiates sample gas with light. The light irradiation unit 10 may include only the infrared light source 1, or may include a laser light source instead of the infrared light source.

The measurement cell 3 is a transparent cell into which sample gas is introduced, and the light emitted from the interferometer 2 is transmitted through the exhaust gas in the measurement cell 3 and guided to the photodetector 4. The spectroscopic analysis device 100 may measure sample gas in the atmosphere or sample gas flowing through a flow path such as a pipe, and in this case, the measurement cell 3 is not an essential configuration.

The photodetector 4 detects the infrared light transmitted through the exhaust gas and outputs a detection signal (light intensity signal) to the arithmetic processing device 5. The photodetector 4 of the present embodiment includes an MCT (HgCdTe) detector, but the photodetector may be a photodetector including other infrared detection elements.

The arithmetic processing device 5 is a computer including an analog electric circuit including a buffer and an amplifier, a digital electric circuit including a CPU, a memory, and a DSP, and an A/D converter and the like interposed therebetween.

The arithmetic processing device 5 calculates a transmitted light spectrum indicating a spectrum of light transmitted through the sample gas from the output value of the photodetector 4, calculates an absorbance spectrum from the transmitted light spectrum, and calculates the concentration of the component to be measured in the sample gas by cooperation of the CPU and its peripheral devices according to the spectroscopic analysis program stored in the memory.

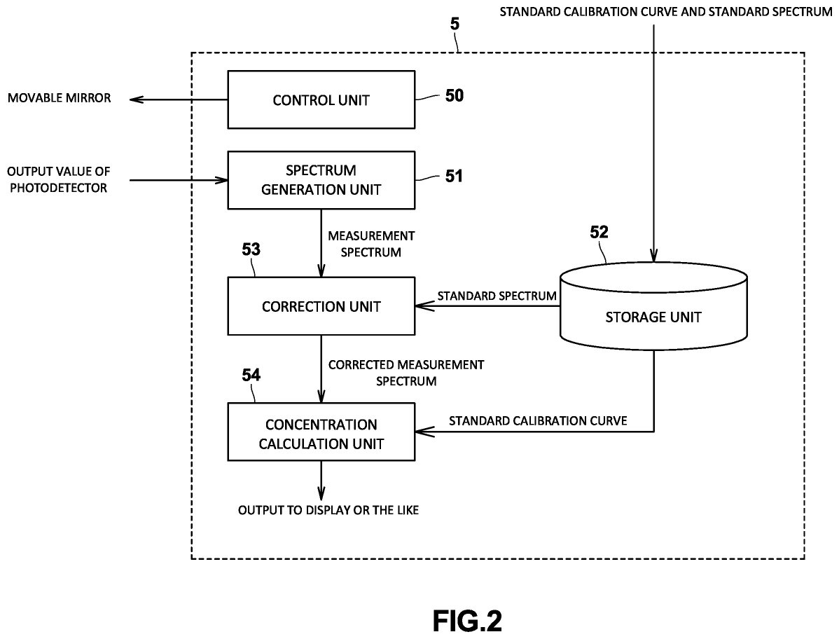

The arithmetic processing device 5 of the present embodiment thus calculates the concentration of the component to be measured in the sample gas using the standard calibration curve of a standard device 200 (see FIG. 1) and exhibits functions as a control unit 50, a spectrum generation unit 51, a storage unit 52, a correction unit 53, a concentration calculation unit 54, and the like as illustrated in FIG. 2. Hereinafter, the spectroscopic analysis device 100 of the present embodiment is also referred to as a target device with respect to the standard device 200.

Here, the standard device 200 is a spectroscopic analysis device serving as a standard of the spectroscopic analysis device 100 of the present embodiment, and the standard calibration curve of the standard device 200 is a calibration curve created using standard gas in the standard device 200. The standard device 200 also generates a standard spectrum that is a spectrum of the standard gas when creating the standard calibration curve.

The standard gas is a gas whose composition and concentration are known, and is, for example, carbon monoxide (CO) gas having a predetermined concentration, methane (CH₄) gas having a predetermined concentration, or nitrogen monoxide (NO) gas having a predetermined concentration. Here, the standard gas may be a single-component gas or a gas containing a plurality of components. The gas type of the standard gas is not limited to the above.

Hereinafter, each of the units 51 to 54 of the arithmetic processing device 5 of the spectroscopic analysis device 100 of the present embodiment will be described.

The control unit 50 controls the operation of the spectroscopic analysis device 100. For example, the control unit 50 controls reciprocation of the movable mirror 23. The control unit 50 may be included in the arithmetic processing device 5 or may be provided separately from the arithmetic processing device 5.

The spectrum generation unit 51 calculates a transmitted light spectrum from the output value (detection signal) of the photodetector 4 and calculates an absorbance spectrum (absorption spectrum) from the transmitted light spectrum. Then, the spectrum generation unit 51 sends the calculated absorbance spectrum to the correction unit 53.

Here, in the spectroscopic analysis device 100 of the present embodiment, the absorbance spectrum of the standard gas obtained by introducing the standard gas into the measurement cell 3 is referred to as “reference spectrum”. The absorbance spectrum of the sample gas obtained by introducing the sample gas into the measurement cell 3 is referred to as “measurement spectrum”.

The storage unit 52 stores the standard calibration curve created using the standard gas in the standard device 200 and the standard spectrum of the standard gas generated by the standard device 200.

The correction unit 53 corrects the measurement spectrum or the standard calibration curve based on a comparison result between the reference spectrum and the standard spectrum. The correction unit 53 of the present embodiment corrects the measurement spectrum.

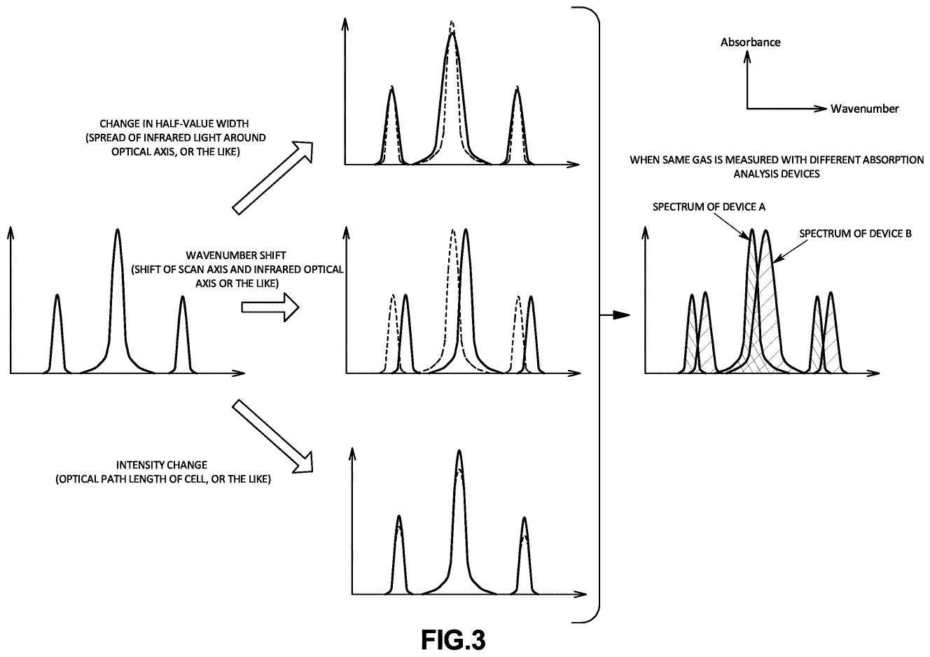

Here, the spectrum measured by the FTIR analysis device is different for different devices in (1) wavenumber, (2) height (intensity change), and (3) half-value width (see FIG. 3) even though the same gas is measured. These differences are caused by the degree of adjustment of the optical system. The wavenumber shift is caused by, for example, a shift of a scan axis of the movable mirror 23, a shift of an infrared optical axis, or the like. The difference in height (intensity change) is caused by, for example, a difference in an optical path length of the measurement cell 3. The difference in half-value width is caused by, for example, spread of infrared light around the optical axis.

These differences can be approximately expressed by the following relational expression.

$$\begin{matrix}[ Math . 2 ] & \\ {A}_{S} ( {κ}_{k} ) = β ( {A}_{M} ( {ακ}_{k} ) * {F}_{G a u s s} ( κ ; {w}_{g} ) ) & ( Q 1 )\end{matrix}$$

$$or$$

$${A}_{S} ( {κ}_{k} ) = β ( {A}_{M} ( α {κ}_{k} ) {*}^{- 1} {F}_{Gauss} ( κ ; {w}_{g} ) ) \qquad ( Q 2 )$$

A_{S}: function representing reference spectrum of target device (spectral analysis device of present embodiment)
A_{M}: function representing standard spectrum of standard device (spectral analysis device as standard)
κₖ: wavenumber value at k-th wavenumber point
α: wavenumber axis scaling ratio between reference spectrum and standard spectrum
β: absorbance scaling ratio between reference spectrum and standard spectrum
w_{g}: difference in half-value width between reference spectrum and standard spectrum

$${F}_{g a u s s} ( κ ; {w}_{g} ) = exp ( - {κ}^{2} / {w}_{g}^{2} )$$

The symbol * represents a convolution operation (convolution).

The symbol *⁻¹ represents a deconvolution operation (deconvolution).

In the relational expression, when the half-value width of the reference spectrum is smaller than the half-value width of the standard spectrum, the former first expression (Q1) is adopted, and in an opposite case, the latter second expression (Q2) is adopted.

Specifically, the correction unit 53 compares the standard spectrum with the reference spectrum and corrects the measurement spectrum based on at least two differences in the wavenumber, the height, or the half-value width of the peak.

More specifically, the correction unit 53 obtains a device difference parameter including at least two of a wavenumber axis scaling ratio α obtained from the wavenumbers of the peaks of the standard spectrum and the reference spectrum, an absorbance scaling ratio β obtained from one or both of the height and the half-value width of the peaks, and a difference w_{g} of the half-value widths obtained from the half-value widths of the peaks. Then, the correction unit 53 corrects the measurement spectrum based on the device difference parameters α, β, and w_{g}.

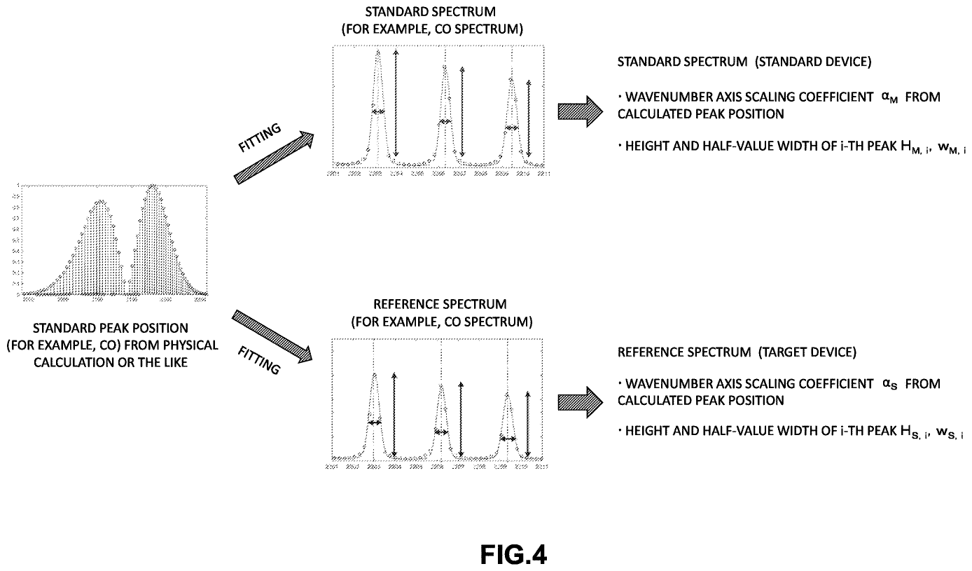

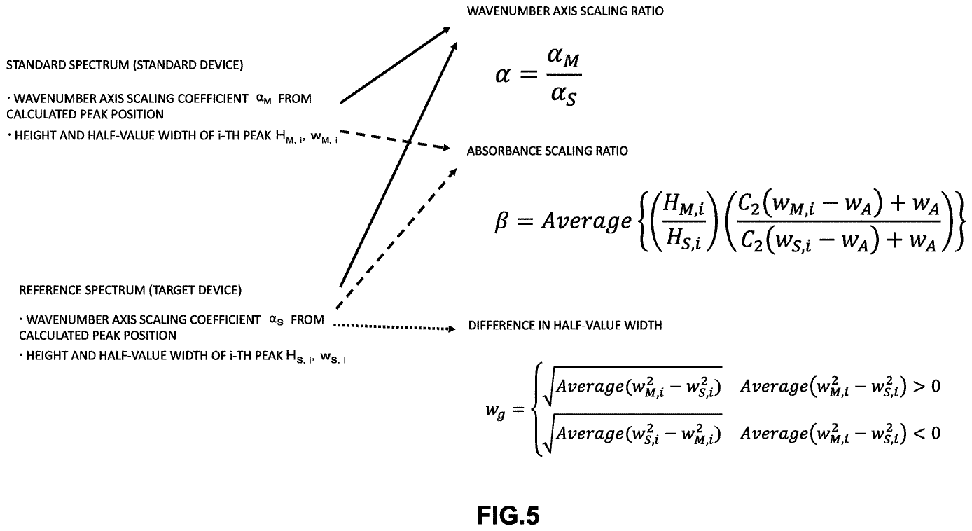

FIGS. 4 and 5 illustrate an example of a method for calculating the device difference parameters with the correction unit 53.

Here, the correction unit 53 obtains a wavenumber axis scaling coefficient α_{M} from the calculated peak positions and the wavenumber of the peaks of the standard spectrum using the calculated peak positions of the gas component (for example, CO) of the standard gas obtained by simulation such as physical calculation. In addition, the correction unit 53 obtains the height H_{M,i} and the half-value width w_{M,i} of the i-th peak of the standard spectrum.

In addition, a wavenumber axis scaling coefficient α_{S} is obtained from the calculated peak positions and the wavenumber of the peaks of the reference spectrum using the above calculated peak positions. In addition, the correction unit 53 obtains the height H_{S,i} and the half-value width w_{S,i} of the i-th peak of the reference spectrum.

Then, the correction unit 53 obtains a wavenumber axis scaling ratio α from the wavenumber axis scaling coefficient α_{M} of the standard spectrum and the wavenumber axis scaling coefficient α_{S} of the reference spectrum using the following formula.

$$\begin{matrix}[ Math . 3 ] & \\ α = \frac{{α}_{M}}{{α}_{S}} & \end{matrix}$$

In addition, the correction unit 53 obtains an absorbance scaling ratio β from the height H_{M,i} and the half-value width w_{M,i} of the i-th peak of the standard spectrum and the height H_{S,i} and the half-value width w_{S,i} of the i-th peak of the reference spectrum using the following formula. C₂ is a constant (about 1.144) unique to the design of the interferometer 2, and w_{A} is a half-value width obtained based on a physical constant depending on absorption characteristic of the component to be measured.

$$\begin{matrix}[ Math . 4 ] & \\ β = Average \{ ( \frac{{H}_{M , i}}{{H}_{S , i}} ) ( \frac{{c}_{2} ( {w}_{M , i} - {w}_{A} ) + {w}_{A}}{{c}_{2} ( {w}_{S , i} - {w}_{A} ) + {w}_{A}} ) \} & \end{matrix}$$

Here, when w_{A} is large, it can be approximated as follows.

$$\begin{matrix}[ Math . 5 ] & \\ β = Average ( \frac{{H}_{M , i}}{{H}_{S , i}} ) & \end{matrix}$$

When w_{A} is small, it can be approximated as follows.

$$\begin{matrix}[ Math . 6 ] & \\ β = Average ( \frac{{H}_{M , i} {w}_{M , i}}{{H}_{S , i} {w}_{S , i}} ) & \end{matrix}$$

Further, the correction unit 53 obtains a difference w_{g} of the half-value widths from the half-value width w_{M,i} of the i-th peak of the standard spectrum and the half-value width w_{S,i} of the i-th peak of the reference spectrum using the following formula.

$$\begin{matrix}[ Math . 7 ] & \\ {w}_{g} = \{ \begin{matrix}\sqrt{Average ( {w}_{M , i}^{2} - {w}_{S , i}^{2} )} & Average ( {w}_{M , i}^{2} - {w}_{S , i}^{2} ) > 0 \\ \sqrt{Average ( {w}_{S , i}^{2} - {w}_{M , i}^{2} )} & Average ( {w}_{M , i}^{2} - {w}_{S , i}^{2} ) < 0\end{matrix} & \end{matrix}$$

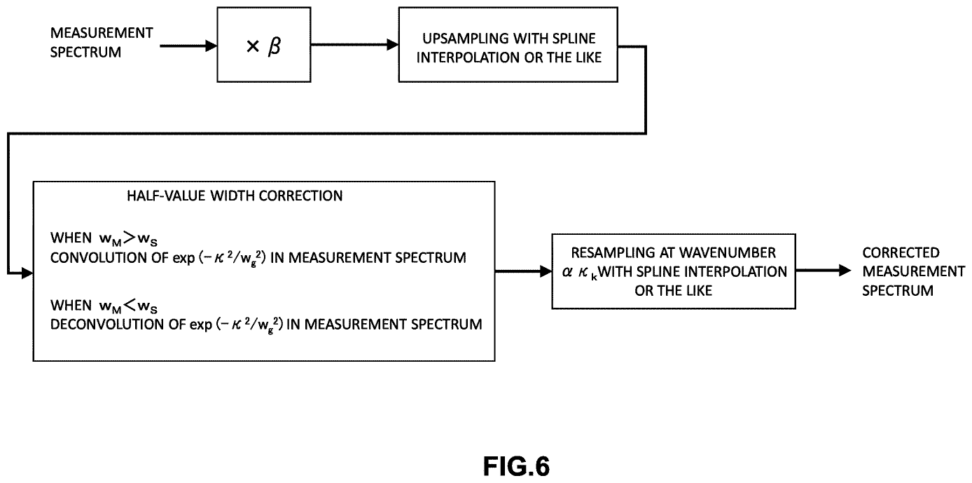

Next, the correction unit 53 corrects the measurement spectrum as illustrated in FIG. 6 using the device difference parameters α, β, and w_{g} obtained as described above.

Specifically, the correction unit 53 multiplies the measurement spectrum by the absorbance scaling ratio β. As a result, the height of the peaks of the measurement spectrum is corrected. In addition, the correction unit 53 performs upsampling processing with spline interpolation or the like on the measurement spectrum multiplied by the absorbance scaling ratio β.

Next, the correction unit 53 performs half-value width correction of the measurement spectrum.

Here, when the half-value width (w_{M}) of the standard spectrum is larger than the half-value width (w_{S}) of the reference spectrum (w_{M}>w_{S}), the correction unit 53 convolutes exp(−κ²/w_{g}²) in the measurement spectrum (convolution operation).

On the other hand, when the half-value width (w_{M}) of the standard spectrum is smaller than the half-value width (w_{S}) of the reference spectrum (w_{M}<w_{S}), the correction unit 53 deconvolutes exp(−κ²/w_{g}²) into the measurement spectrum (deconvolution operation).

Thereafter, the correction unit 53 resamples the measurement spectrum with the corrected half-value width at a wavenumber ακₖ using spline interpolation or the like. As a result, the wavenumber shift of the measurement spectrum is corrected.

Through the above processing, the measurement spectrum is corrected using the device difference parameters α, β, and w_{g}. The correction operation of the measurement spectrum is not limited to the above order. The correction of the height of the peaks of the measurement spectrum, the half-value width correction of the measurement spectrum, and the wavenumber shift correction of the measurement spectrum may be performed in any order.

The concentration calculation unit 54 calculates the concentration of the component to be measured based on the measurement spectrum corrected by the correction unit 53 and the standard calibration curve.

Specifically, the concentration calculation unit 54 calculates the concentration of the component to be measured c_{X} from the following formula using the corrected measurement spectrum A′(λₖ) and the standard calibration curve (standard calibration curve coefficient) v_{X,k}.

$$\begin{matrix}[ Math . 8 ] & \\ {c}_{X} = {\sum }_{k} {v}_{X , k} {A}^{′} ( {λ}_{k} ) & \end{matrix}$$

In (Mathematical Formula 6), the standard calibration curve coefficient may be corrected instead of calculating the concentration using the measurement spectrum corrected using the device difference parameters. The correction of the measurement spectrum using the device difference parameters can be expressed as follows using a matrix M determined by at least two of α, β, and w_{g}. Here, the matrix M is obtained by multiplying at least two of a matrix using a for correcting the wavenumber shift, a matrix using β for correcting the intensity change, and a matrix using ω_{g} for correcting the half-value width.

$$\begin{matrix}[ Math . 9 ] & \\ [ \begin{matrix}{A}^{′} ( {λ}_{1} ) \\ ⋮ \\ {A}^{′} ( {λ}_{k} )\end{matrix} ] = M [ \begin{matrix}A ( {λ}_{1} ) \\ ⋮ \\ A ( {λ}_{k} )\end{matrix} ] & \end{matrix}$$

With such a matrix M, a corrected calibration curve coefficient v′_{X,k} is determined from the following formula. The superscript T represents transposition of the matrix.

$$\begin{matrix}[ Math . 10 ] & \\ [ \begin{matrix}{v}_{X , 1}^{′} \\ ⋮ \\ {v}_{X , K}^{′}\end{matrix} ] = {M}^{T} [ \begin{matrix}{v}_{X , 1} \\ ⋮ \\ {v}_{X , K}\end{matrix} ] & \end{matrix}$$

Then, with the following formula, the concentration can be calculated using the standard calibration curve coefficient corrected using the device difference parameters.

$$\begin{matrix}[ Math . 11 ] & \\ & \end{matrix}$$

$${\sum }_{k} {v}_{X , k}^{′} A ( {λ}_{k} ) = {[ \begin{matrix}{v}_{X , 1}^{′} \\ ⋮ \\ {v}_{X , K}^{′}\end{matrix} ]}^{T} [ \begin{matrix}A ( {λ}_{1} ) \\ ⋮ \\ A ( {λ}_{k} )\end{matrix} ] = {( {M}^{T} [ \begin{matrix}{v}_{X , 1} \\ ⋮ \\ {v}_{X , K}\end{matrix} ] )}^{T} [ \begin{matrix}A ( {λ}_{1} ) \\ ⋮ \\ A ( {λ}_{k} )\end{matrix} ] = {[ \begin{matrix}{v}_{X , 1} \\ ⋮ \\ {v}_{X , K}\end{matrix} ]}^{T} M [ \begin{matrix}A ( {λ}_{1} ) \\ ⋮ \\ A ( {λ}_{k} )\end{matrix} ] = {[ \begin{matrix}{v}_{X , 1} \\ ⋮ \\ {v}_{X , K}\end{matrix} ]}^{T} [ \begin{matrix}{A}^{′} ( {λ}_{1} ) \\ ⋮ \\ {A}^{′} ( {λ}_{k} )\end{matrix} ] = {\sum }_{k} {v}_{X , k} {A}^{′} ( {λ}_{k} ) = {c}_{X}$$

### <Spectroscopic Analysis Method>

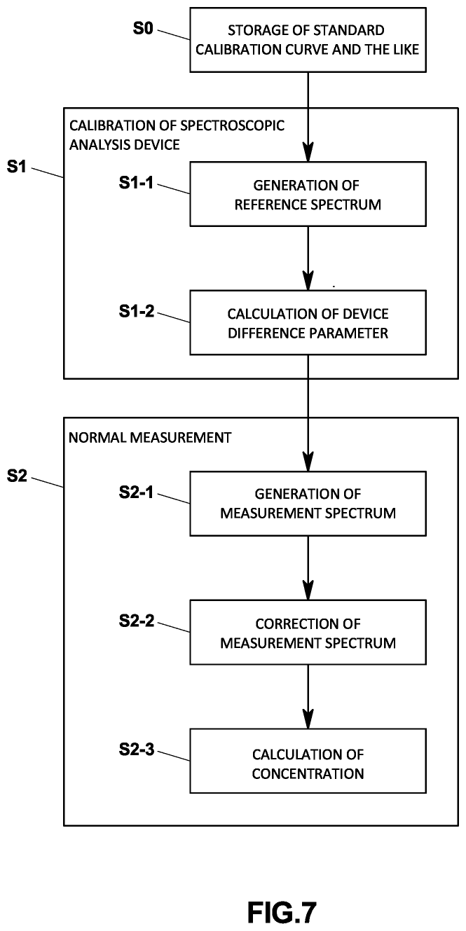

Next, a spectroscopic analysis method using the spectroscopic analysis device 100 of the present embodiment will be described with reference to FIG. 7.

### (S0: Storage of Standard Calibration Curve and the Like)

First, the standard device 200 generates a standard calibration curve and a standard spectrum that is a spectrum of a standard gas using the standard gas. The standard calibration curve and the standard spectrum thus obtained are stored in the storage unit 52 of the spectroscopic analysis device 100 (target device) of the present embodiment. When there are a plurality of types of standard gases, a standard calibration curve and a standard spectrum are generated for each standard gas and stored in the storage unit 52.

### (S1: Calibration of Spectroscopic Analysis Device)

The spectroscopic analysis device 100 of the present embodiment is periodically calibrated. In the calibration of the spectroscopic analysis device 100, a calibration curve (calibration curve coefficient) is not obtained, but the device difference parameters α, β, and w_{g} are obtained.

### (S1-1: Generation of Reference Spectrum)

Then, the standard gas is introduced into the measurement cell 3 of the spectroscopic analysis device 100 of the present embodiment to perform spectroscopic analysis. As a result, the spectrum generation unit 51 generates a reference spectrum that is a spectrum of the standard gas. Here, the reference spectrum does not need to be generated by introducing the standard gas for all the components to be measured. The reference spectrum may be generated by introducing the standard gas for at least one of the components to be measured. In this case, for a component to be measured whose reference spectrum is not generated by introducing the standard gas, the reference spectrum may be calculated using a reference spectrum of a component having a close wavelength region among the components to be measured whose reference spectra are generated by introducing the standard gas, or may be calculated using an average value of reference spectra generated by introducing the standard gas.

### (S1-2: Calculation of Device Difference Parameter)

When the reference spectrum is generated by the spectrum generation unit 51, the correction unit 53 calculates the device difference parameters α, β, and w_{g} based on the reference spectrum and the standard spectrum stored in the storage unit 52. The calculated device difference parameters α, β, and w_{g} are stored in a memory such as the storage unit 52.

### (S2: Normal Measurement)

After the device difference parameters α, β, and w_{g} are obtained as described above, normal measurement of the sample gas is performed.

### (S2-1: Generation of Measurement Spectrum)

Specifically, sample gas is introduced into the measurement cell 3 of the spectroscopic analysis device 100 of the present embodiment, and absorption analysis is performed. As a result, a measurement spectrum that is a spectrum of the sample gas is generated by the spectrum generation unit 51.

### (S2-2: Correction of Measurement Spectrum)

The correction unit 53 corrects the measurement spectrum generated by the spectrum generation unit 51 using the device difference parameters α, β, and w_{g}.

### (S2-3: Calculation of Concentration)

Then, the concentration calculation unit 54 calculates the concentration of the component to be measured using the measurement spectrum corrected by the correction unit 53 and the standard calibration curve (coefficient) stored in the storage unit 52.

### Effects of Present Embodiment

In the spectroscopic analysis device 100 of the present embodiment configured as described above, the reference spectrum of the standard gas generated by the spectrum generation unit 51 is compared with the standard spectrum that is the spectrum of the standard gas generated by the standard device 200, and the measurement spectrum of the sample generated by the spectrum generation unit 51 is corrected based on the difference in the wavenumber or half-value width of the peaks. Thus, the concentration of the component to be measured can be obtained with good accuracy without obtaining a calibration curve of the spectroscopic analysis device 100 that is the target device. In addition, since it is not necessary to obtain a calibration curve for each spectroscopic analysis device 100, labor costs and time for creating the calibration curve can be reduced, and the cost of consumables such as gas for creating the calibration curve can also be reduced.

### Other Embodiments

For example, in the above embodiment, the measurement spectrum is corrected using three of the wavenumber axis scaling ratio α, the absorbance scaling ratio β, and the difference w_{g} of the half-value width as the device difference parameters, but the measurement spectrum may be corrected using at least two of them.

In the above embodiment, the measurement spectrum may be corrected assuming that the half-value widths of the peaks are equal, the measurement spectrum may be corrected assuming that the wavenumbers of the peaks are equal, or the measurement spectrum may be corrected assuming that the heights of the peaks are equal.

In the above embodiment, the wavenumber axis scaling coefficients α_{M} and α_{S} obtained using the calculated peak positions of the gas component (for example, CO) of the standard gas obtained through simulation such as physical calculation are used in obtaining the wavenumber axis scaling ratio α, but the wavenumber axis scaling ratio α may be obtained from the peak interval of the standard spectrum and the peak interval of the reference spectrum without using the calculated peak positions.

Further, the correction unit may estimate at least two of the device difference parameters α, β, and w_{g} by using a learned model obtained in advance. The learned model is a model that outputs the device difference parameters α, β, and w_{g} from a reference spectrum when the reference spectrum is input, and the model is generated through learning with a learning device.

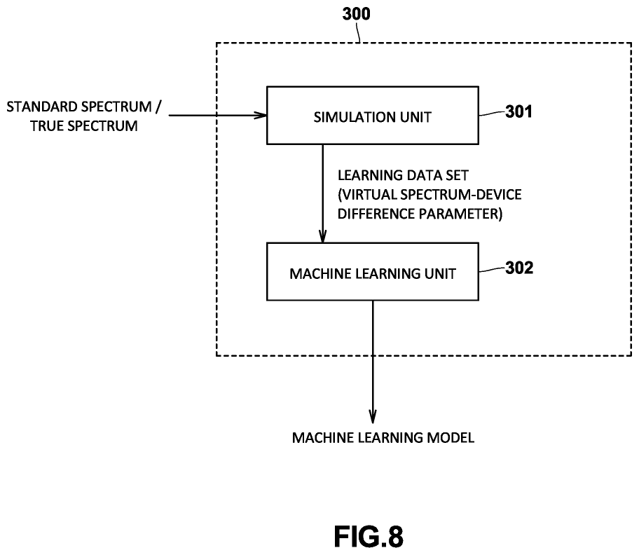

As an aspect of the learning, machine learning can be used. As illustrated in FIG. 8, a machine learning device 300 that generates the above-described learned model includes a simulation unit 301 that generates a plurality of virtual spectra based on a standard spectrum or a true spectrum (ideal spectrum) and each of a plurality of device difference parameters, and a machine learning unit 302 that generates a machine learning model based on a learning data set including the plurality of virtual spectra generated by the simulation unit 301 and the plurality of device difference parameters used to generate the virtual spectra.

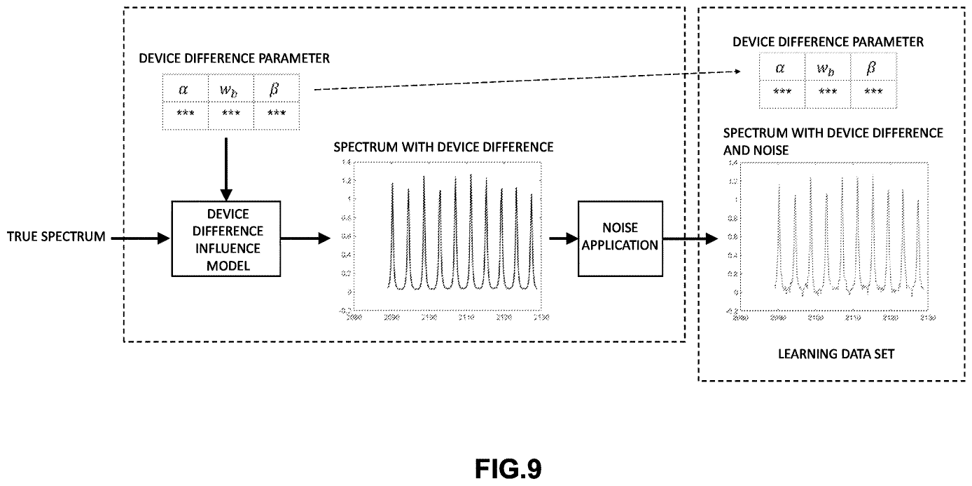

Here, as illustrated in FIG. 9, the simulation unit 301 has a device difference influence model created in advance and creates a spectrum with device difference (virtual spectrum) from the standard spectrum or the true spectrum and the device difference parameters using the device difference influence model. Since the reference spectrum obtained through actual measurement includes a noise component, the simulation unit 301 of FIG. 9 applies a noise component to each of the plurality of virtual spectra to reproduce the noise component. In this case, the machine learning unit generates the machine learning model based on the learning data set including the plurality of virtual spectra to which the noise component is applied and the plurality of device difference parameters used to generate the virtual spectra. The simulation unit 301 may add no noise component to the virtual spectra.

The spectroscopic analysis device of the above embodiment uses Fourier transform infrared spectroscopy (FTIR). However, the spectroscopic analysis device can be applied to a spectroscopic analysis device that acquires a spectrum and calculates a concentration. For example, the spectroscopic analysis device may use mid-infrared laser spectroscopy (QCL-IR), infrared laser absorption modulation (IRLAM), or other laser absorption spectroscopy.

Other various modifications and combinations of the embodiments may be made without departing from the spirit of the present invention.

### INDUSTRIAL APPLICABILITY

The present invention can obtain the concentration of a component to be measured with good accuracy from a measurement spectrum without obtaining a calibration curve for each spectroscopic analysis.

### REFERENCE SIGNS LIST

100 spectroscopic analysis device (target device)
200 standard device
51 spectrum generation unit
52 storage unit
53 correction unit
54 concentration calculation unit

1. A spectroscopic analysis device that irradiates a sample with light to analyze a component to be measured contained in the sample, the spectroscopic analysis device comprising:
a light irradiation unit that irradiates the sample with light;
a photodetector that detects light transmitted through the sample and obtains a detection signal;
a spectrum generation unit that generates a spectrum of light transmitted through the sample based on the detection signal;
a storage unit that stores a standard calibration curve and a standard spectrum, the standard calibration curve being created by a standard device serving as a standard of the spectroscopic analysis device using a standard gas, the standard spectrum being a spectrum of the standard gas generated by the standard device;
a correction unit that compares a reference spectrum that is a spectrum of the standard gas generated by the spectrum generation unit with the standard spectrum and corrects a measurement spectrum that is a spectrum of the sample generated by the spectrum generation unit or the standard calibration curve based on a difference in wavenumber or half-value width between peaks of the reference spectrum and the standard spectrum; and
a concentration calculation unit that calculates a concentration of the component to be measured based either on the standard calibration curve and the measurement spectrum that has been corrected or on the standard calibration curve that has been corrected and the measurement spectrum.

2. The spectroscopic analysis device according to claim 1, wherein the correction unit compares the standard spectrum with the reference spectrum and corrects the measurement spectrum or the standard calibration curve based on at least two of a difference in wavenumber, a difference in height, or a difference in half-value width between the peaks of the reference spectrum and the standard spectrum.

3. The spectroscopic analysis device according to claim 1, wherein the correction unit obtains a device difference parameter including at least two of a wavenumber axis scaling ratio α obtained from the wavenumber of the peaks of the standard spectrum and the reference spectrum, an absorbance scaling ratio β obtained from one or both of a height and the half-value width of the peaks, or a difference w_{g} between half-value widths obtained from half-value widths of the peaks, and corrects the measurement spectrum or the standard calibration curve based on the device difference parameter.

4. The spectroscopic analysis device according to claim 3, wherein the correction unit estimates the device difference parameter using a learning model obtained in advance.

5. A spectroscopic analysis method using a spectroscopic analysis device that irradiates a sample with light to analyze a component to be measured contained in the sample, the spectroscopic analysis method comprising:
using a standard calibration curve created by a standard device serving as a standard of the spectroscopic analysis device using a standard gas, and a standard spectrum that is a spectrum of the standard gas generated by the standard device;
comparing a reference spectrum that is a spectrum of the standard gas generated by the spectroscopic analysis device with the standard spectrum to correct a measurement spectrum that is a spectrum of the sample generated by the spectroscopic analysis or the standard calibration curve based on a difference in wavenumber or half-value width between peaks of the reference spectrum and the standard spectrum; and
calculating a concentration of the component to be measured based on the standard calibration curve and the measurement spectrum that has been corrected or the standard calibration curve that has been corrected and the measurement spectrum.

6. A non-transitory computer-readable medium having instructions stored thereon defining a spectroscopic analysis program used in a spectroscopic analysis device that irradiates a sample with light to analyze a component to be measured contained in the sample, the instructions when executed by a computer cause the computer to:
function as a spectrum generation unit that generates a spectrum of light transmitted through the sample;
function as a storage unit that stores a standard calibration curve and a standard spectrum, the standard calibration curve being created by a standard device serving as a standard of the spectroscopic analysis device using a standard gas, the standard spectrum being a spectrum of the standard gas generated by the standard device;
function as a correction unit that compares a reference spectrum that is a spectrum of the standard gas generated by the spectrum generation unit with the standard spectrum and corrects a measurement spectrum that is a spectrum of the sample generated by the spectrum generation unit or the standard calibration curve based on a difference in wavenumber or half-value width between peaks of the reference spectrum and the standard spectrum; and
function as a concentration calculation unit that calculates a concentration of the component to be measured based on the standard calibration curve and the measurement spectrum corrected by the correction unit or the standard calibration curve corrected by the correction unit and the measurement spectrum.

7. A learning device that generates the learning model according to claim 4, the learning device comprising:
a simulation unit that generates a plurality of virtual spectra based on the standard spectrum and each of a plurality of the device difference parameters; and
a learning unit that generates a learned model based on a learning data set including the plurality of virtual spectra generated by the simulation unit and the plurality of device difference parameters used to generate the virtual spectra.

8. The learning device according to claim 7, wherein
the simulation unit applies a noise component to each of the plurality of virtual spectra, and
the learning unit generates the learned model based on a learning data set including the plurality of virtual spectra to which the noise component is given and the plurality of device difference parameters used to generate the virtual spectra.

9. A learning method for generating the learning model according to claim 4, the learning method comprising:
generating a plurality of virtual spectra based on the standard spectrum and each of a plurality of the device difference parameters; and
generating a learned model based on a learning data set including the plurality of virtual spectra that have been generated and the plurality of device difference parameters used to generate the virtual spectra.

10. A non-transitory computer readable medium having instructions stored thereon defining a learning program for generating the learning model according to claim 4, the instructions when executed by a computer cause the computer to:
function as a simulation unit that generates a plurality of virtual spectra based on the standard spectrum and each of a plurality of the device difference parameters; and
function as a learning unit that generates a learned model based on a learning data set including the plurality of virtual spectra that have been generated and the plurality of device difference parameters used to generate the virtual spectra.
